(19) United States
(12) Patent Application Publication
(10) Pub. No.: US 2005/0221056 A1
(43) Pub. Date: Oct. 6, 2005

(54) Multi-layered plastic strip or plate having a three-dimensional optical aspect, method for the production and use thereof

(76) Inventors: Karl-Heinz Schwonke, Lochgau (DE); David P. Reichwein, Elizabethtown, PA (US)

Correspondence Address: SUGHRUE MION, PLLC, 2100 PENNSYLVANIA AVENUE, N.W., SUITE 800, WASHINGTON, DC, 20037, US

(21) Appl. No.: 10/509,392

(22) PCT Filed: Mar. 28, 2003
(86) PCT No.: PCT/EP03/03289

§ 371 Date: May 4, 2005

(30) Foreign Application Priority Data
Mar. 28, 2002 (DE) 10214100.2

(51) Int. Cl. B32B 3/00

(52) U.S. Cl. 428/172

(57) ABSTRACT

A flexible floor covering with regenerative, soiling-resistant surfaces is disclosed, comprising a matrix based on natural or synthetic materials an at least one substance incompatible with said matrix. Said flexible floor covering preferably comprises a surface with a pre-determined structure and a matrix in which a particulate material harder than the matrix itself is embedded. The floor covering is characterized in having an improved soiling property and an increased wear resistance.

The present invention relates to a multilayer plastic web or sheet having a three-dimensional optical appearance. Furthermore, this invention relates to a method for producing the plastic web or sheet as well as the use thereof.

Multilayer plastic webs or sheets in the sense of the present invention are understood to refer to sheets consisting of at least two layers that are bonded together. Such plastic webs or sheets may be used for paneling walls or for ceilings, as decorative film or synthetic veneer and in particular as floor covering.

Multilayer plastic webs based on polyvinylchloride (PVC) with a transparent cover layer as the wear layer have been used for many decades as floor coverings. However, other plastics, i.e., polymers such as ethylene-vinyl acetate (EVA) copolymers, plastics based on olefinic polymers such a polyethylene (PE), polypropylene (PP), ethylene-propylene copolymers and copolymers of ethylene with other olefinic unsaturated compounds are also used to produce floor coverings. A multilayer plastic sheet or panel used as a floor covering consists of at least two layers, a transparent cover layer or wear layer, respectively (also known as a clear layer or clear film) and a base layer (also known as base film). Another layer (referred to as the print film, white film, printing film, print carrier or printed white film) is often arranged between the cover layer and the base layer.

To produce a pattern, the transparent cover layer (clear layer) may be printed in one or more colors on its underside, i.e., the surface facing the base layer. Additionally or alternatively, the base layer may also be printed with one or more colors on its surface facing the cover layer. Preferably up to 16 different colors, especially preferably up to 8 colors, are used for the printing, i.e., patterning.

If another nontransparent layer (white film) is arranged between the cover layer and the base layer, the patterning is applied to the surface of the additional layer facing the cover layer, either additionally or instead of the pattern on the underside of the transparent cover layer, because in this case the base layer is not visible.

Each of the aforementioned layers, in particular the cover layer and the base layer, may be designed in one or more layers itself. For technical production reasons and from a cost standpoint, it is often more advantageous to join together two or more thin films, e.g., transparent films (e.g., by lamination) to obtain a thick cover layer accordingly than to produce the layer in its desired thickness in one operation.

The individual layers may be manufactured from the same basic material but this is not necessary provided the layers can be joined together in a nonpositive manner. Since only the cover layer need be transparent, there is a relatively great deal of freedom in the choice of plastics and/or plastic blends and additives in the other layer (white film) and in particular in the base layer. For practical reasons, the base layer is produced from up to 80% recycled material (also called scrap). This recycled material may be, for example, chopped material from used floor coverings as well as waste material from the production of new floor coverings, e.g., trimmings and the like.

Multilayer plastic sheets or panels based on PVC for use as floor covering are usually constructed from the following layers:
Transparent cover layer (clear layer); thickness between approximately 0.05 mm and approximately 4 mm, preferably between approximately 0.1 mm and approximately 2 mm. The clear layer may be laminated from one to eight individual films, one to four individual films being preferred.
White film (print film), optionally pigmented and/or printed; thickness between approximately 0.05 mm and approximately 0.3 mm, preferably between 0.1 and 0.2 mm.
Base layer (base film) in any color; thickness between approximately 0.05 mm and approximately 4 mm, preferably between approximately 0.3 and 2 mm. The base layer may be laminated from one to six individual films, one to three individual films being preferred.

The total thickness of the multilayer plastic sheets or panels is between approximately 0.7 and approximately 10 mm, a total thickness between approximately 1 mm and approximately 5 mm being preferred.

Typically the cover layer is produced from a laminate of two transparent films each having a thickness of approximately 5 mm. The thickness of an intermediate layer (white film) is generally approximately 0.10 to 0.12 mm and the base layer is frequently formed from a laminate of at least two films, like the cover layer, each of the two films being approximately 0.7 mm to 0.8 mm thick.

In addition to the aforementioned layers, other layers may also be provided as needed. For example, a layer for foot fall sound attenuation or for thermal insulation may also be provided between the white film and the base layer or as the last layer beneath the base layer. Furthermore, an adhesive layer may also be provided as the bottommost layer so that the multilayer plastic sheets or panels are self-stick. This is advantageous with floor coverings in particular.

When using the inventive plastic sheets or panels as floor coverings, it is preferable for a finish to be applied to the surface of the wear layer, i.e., the clear layer, to protect it and for ease of care and/or cleaning of the floor covering. To this end, conventional cleaning and care substances may be applied to preserve and/or restore the optical properties. In the normal case, these will be wax dispersions having a high polymer content, forming a film approximately 5 μm thick to approximately 10 μm thick, which will act as a protective layer for the duration of its presence. Alternatively, the floor coverings, in particular PVC floor coverings, may be sealed with varnishes based on polyurethane (so-called PU sealing). Such PU sealing, whether water based or solvent free, e.g., UV curing, will normally have layer thicknesses in the range of approximately 5 μm to approximately 50 μm.

The individual films are traditionally bonded together in a nonpositive manner in an automatic laminating machine (also called an AUMA). Using pressure (typically 8 to 30 N/cm²) and temperature (typically approximately 170 to 195° C.) for a period of approximately 1 to 1.5 minutes. To make the smooth surface of the floor covering less sensitive to scratching and to reinforce the optical appearance of the print pattern, a surface embossing is often performed after laminating the layers. A three-dimensional optical appearance, i.e., the optical impression that the floor covering has a three-dimensional structure despite a planar design, cannot be achieved in this way.

Therefore, one object of the present invention is to provide a multilayer plastic sheet or panel having a three-dimensional optical appearance. Another object of the present invention is to provide a method with which a multilayer plastic sheet or panel having a three-dimensional optical appearance can be produced easily and inexpensively, whereby traditional machines can still be used for the production of such sheeting without any great increase equipment expense.

These objects are achieved through the objects defined in the claims, with advantageous refinements of this invention being characterized in the subclaims.

This invention is based on the finding that a multilayer plastic sheet or panel having a marked three-dimensional optical appearance can be produced by providing the base film with embossing on one side of its surface before lamination and then bonding the cover layer and optionally the additional layer (white film) together in a nonpositive manner under a certain temperature program which depends on the softening points of the respective layers.

It is possible according to this invention to almost authentically transfer the embossing structure of the base film into the underside of the cover layer and/or in the case when there are additional layers, to transfer it through this additional layer into the underside of the cover layer.

To produce the inventive plastic webs or sheets, the equipment and machinery conventionally used for the production of floor covering may be used, and essentially the only additional step is one-sided embossing of the base layer on its surface facing the cover layer, and the temperature program in lamination must be controlled accordingly.

In the manner according to this invention it is also possible to easily transfer sharply defined structures into the underside of the cover layer, whereby a definitely pronounced three-dimensional optical appearance can be represented. According to this invention, embossing with an embossing depth ranging from approximately 0.01 mm to approximately the thickness of the base layer can be achieved on the top side of the base layer. At a base layer thickness of 4 mm, for example, it is readily possible to achieve embossings having sharp contours with an embossing depth of approximately 3.5 mm. The three-dimensional optical appearance of the web can be further increased and a high quality appearance imparted to the web by an even embossing applied to the top side of the finished laminate, i.e., the useful surface or wear surface in the case of a floor covering.

The plastic webs or sheets according to this invention are produced in a known way as described above. The coloring and/or patterning is also performed in the traditional way, i.e., the transparent cover layer can be backprinted and additionally or alternatively the top side of the embossed base layer can be printed or, if present, the top side of the additional layer (white film) may be printed.

According to this invention it is preferable for the layers to consist of prefabricated films, whereby the layers, in particular the thicker layers such as the cover layer and the base layer, may be laminates of two or more thinner films.

The inventive plastic web or sheet preferably has an additional embossing on its top surface (wear layer in the case of a floor covering) which may have either an irregular embossing, e.g., a fine embossing, e.g., a fine embossing for delustering the surface or an embossing which communicates with the surface embossing of the base layer, thereby allowing the three-dimensional optical appearance of the plastic web to be enhanced or modified.

The additional embossing on the top surface is preferably a uniform embossing, i.e., an embossing with a regular pattern of elevations and depressions because the soiling behavior of a floor covering, for example, can be improved significantly by such an embossing. This effect is also known as the “lotus effect.” It has been found that the effect of the additional surface structuring is most pronounced when the average distance between profile tips in the midline corresponding to the so-called Sm value or groove spacing Sm according to DIN 4768 is in a range of greater than 200 μm and less than 1000 μm.

With regard to the height of the elevation (average roughness or peak-to-valley height R_{z} according to DIN 4768) of the embossed material, a value in the range of 20 μm to 200 μm has proven to be advantageous. The embossing may be achieved with an embossing roller, for example.

The material for the matrix of the individual layers and/or films of the inventive plastic webs or sheets is not subject to any particular restriction and may be selected, for example, from polyvinylchloride (PVC), ethylene-vinyl acetate copolymer (EVA), homo and copolymers of ethylenically unsaturated compounds, ethylene-alkyl acrylate copolymers, ethylene-propylene-diene copolymers (EPDM), diene-containing copolymers such as styrene-butadiene-styrene (SBS) block copolymers and styrene-isoprene-styrene (SIS) block copolymers and the like.

Because of its excellent use properties, in particular when used as a floor covering, a material based on PVC is preferred.

Depending on the type of layer, the layers may contain plasticizers and conventional additives such as fillers, coloring agents such as pigments and organic and inorganic dyes and additives.

Examples of fillers include chalk, barium sulfate, shale, silica, kaolin, quartz powder, talc, lignin, cellulose, glass powder, textile or glass fibers, cellulose fibers and polyester fibers which may be used in an amount from approximately 20 wt % to 80 wt %, based on the total weight of the respective layer. The additives include, for example, antioxidants, antistatics, stabilizers, UV absorbers, propellants, fungicides, lubricants and processing aids in the usual amounts.

For production of the inventive plastic webs or sheets with a three-dimensional optical appearance based on PVC, the individual films for the transparent cover layer, the white film and the base layer are produced from the following starting materials in the stated quantities:
The PVC used is obtained by conventional polymerization processes such as suspension polymerization (S-PVC), emulsion polymerization (E-PVC) and substance or bulk polymerization (M-PVC) with molecular weights of approximately 30,000 to approximately 130,000 g/mol, which corresponds to K values of approximately 45 to approximately 80. K values from approximately 60 to approximately 70 are preferred, and are more preferably approximately 65. Mixtures of different types of PVC may also be used. In addition scrap material, i.e., recycled material may be used for the base layer because transparency and color are not important here.

Essentially all conventional plasticizers may be used here such as phthalic acid esters, trimellitic acid esters, phosphoric acid esters, benzoic acid esters, polymer plasticizers such as polyesters of adipic acid, sebacic acid, azelaic acid and phthalic acid with diols, etc.

Preferred according to this invention are the esters of phthalic acid such as dioctyl phthalate (DOP), bis(2-ethylhexyl) phthalate, diisononyl phthalate (DINP), diisododecyl phthalate (DIDP), dibutyl phthalate (DBP), diethyl phthalate (DEP), benzylbutyl phthalate (BBP), butyloctyl phthalate, dipentyl phthalate and the like.

Typical compositions for the individual films are as follows:

Transparent Layer

| | Quantity range | Preferred quantity |
|---|---|---|
| Starting | (wt %) | range (wt %) |
| PVC | 60-95 | 65-80 |
| Plasticizer | 5-35 | 10-30 |
| Stabilizer | 0.1-8 | 0.5-5 |
| Antistatics | 0.1-4 | 0.2-2 |

White Film (Print Film)

| | Quantity range | Preferred quantity |
|---|---|---|
| Starting | (wt %) | range (wt %) |
| PVC | 60-95 | 65-80 |
| Plasticizer | 5-35 | 10-30 |
| Stabilizer | 0.1-8 | 0.5-5 |
| Antistatics | 0.1-4 | 0.2-2 |
| Pigment | 2-12 | 3-7 |

Base layer

| | Quantity range | Preferred quantity |
|---|---|---|
| Starting | (wt %) | range (wt %) |
| PVC scrap | 10-80 | 30-70 |
| PVC new material | 10-80 | 5-50 |
| Plasticizer | 0-50 | 1.5-40 |
| Stabilizer | 0-5 | 0-3 |
| Antistatics | 0-4 | 0-2 |
| Lubricant | 0-2 | 0.2-0.7 |
| Filler | 0-80 | 0-50 |
| Pigment | 0-2 | 0.2-1 |

To achieve the most pronounced possible three-dimensional optical appearance, i.e., with sharp edges and clear lines and boundaries, it is of crucial importance according to this invention to select the materials for the individual layers with regard to their softening point and/or a certain temperature program in nonpositive bonding of the individual layers and/or films.

It has been found that the inventive effect, namely an excellent three-dimensional optical appearance of the plastic web can be achieved when the transparent cover layer and the additional layer optionally present are already much softer when bonded to the base layer than the base layer which is embossed on one side on the surface. In the most favorable case, the base layer is hard when compressed with the other layers while the cover layer and the other layer optionally present have already definitely approached or exceeded their softening points. Under these conditions, the embossing of the surface of the base layer is transferred almost unchanged to and/or into the underside of the cover layer, optionally through the additional layer. Because of the small thickness of the additional layer, its softening point is less critical than that of the much thicker transparent cover layer.

For said reasons it is advantageous that the transparent cover layer and the additional layer optionally provided between the cover layer and the base layer each have a softening point lower than the base layer. The softening point of the cover layer and that of the intermediate layer are preferably lower by at least 10° C., more preferably by at least 15° C. and most preferably by at least 20° C. than that of the base layer.

As a measure of the hardness suitable for surface embossing of the base layer, the so-called indentation index of the base layer may be used; it is determined as follows.

First, the thickness of the finished base layer is measured. Then the base layer is loaded at one location with a steel pin with a diameter of 4.6 mm at a pressure of 55 kg for 60 seconds at 23° C. and 50% relative atmospheric humidity. After the pressure is released, the thickness of the base layer at this point is measured and the indentation index is calculated from the measured data according to the following equation:
Indentation index=indentation depth (mm)/original layer thickness (mm)×100%

As part of this invention, a suitable base layer has an indentation index of 20-80%, preferably 25-60%.

However, to achieve the effect according to this invention, it is also possible to use materials whose softening points differ little or not at all for the individual layers. In this case, the temperature program in nonpositive bonding by lamination, for example, should be designed so that the temperature is higher on the side of the cover layer than on the side of the base layer, so that the temperature penetrates from the cover layer to the base layer and thus there is a temperature gradient. When using an AUMA for laminating the layers, this temperature program can be achieved easily by heating the drum and/or roller which is in contact with the cover layer. If necessary, the base layer may additionally be cooled.

When there are unfavorable relationships for the softening points of the individual layers, e.g., in the case when the cover layer has a higher softening point than the base layer, the cover layer may be preheated before sending it to the lamination machine to soften it accordingly. All other process parameters can be retained in comparison with the standard method when using an AUMA.

The use of an AUMA for laminating the individual films has the advantageous effect that the woven structure of the jointly running belt carried along between the printing belt and the base layer is transferred to the underside of the base film. The fabric imprint increases the adhesion of the floor covering when it is bonded with pressure-sensitive adhesives to the substrate because the adhesive compound can penetrate into the recesses and thus the surface area in contact with the adhesive is increased.

The inventive multilayer plastic webs or sheets can be produced in the following way:

First, a layer and/or a film and/or a laminate of two or more films of a thermoplastic material is provided in a known way and the prefabricated layer is embossed on one surface on one side to obtain a superficially embossed base layer. The embossing may be performed constantly before joining this layer to the other layers of the plastic web in a separate operation, but also immediately before lamination, so to speak online before the nonpositive bonding of the layers.

Furthermore, a transparent cover layer in the form of a film or a laminate of two or more films of a thermoplastic material is likewise provided in a known way.

Then the cover layer is arranged over the base layer in such a manner that it is opposite the embossed surface of the base layer and/or the two layers are fed in this arrangement to a machine for the nonpositive bonding, e.g., an AUMA.

If another layer (white film) is provided, it is arranged between the transparent cover layer and the embossed base layer and/or between the cover layer and the base layer of the apparatus for joining the layers.

The processing conditions in the production of the films (clear film, print film, base film) depend on the respective layer thickness, the material to be processed, etc. and are as follows in particular in the case of production of films based on PVC:

Bulk temperatures of the mixture to be calendered, comprised of, for example, plastic, optional fillers, additives, processing aids, optional pigments and/or dyes, etc.: 140 to 220° C., preferably 160 to 195° C.

Calender temperature: 140-230° C.; preferably 160-195° C.

Calender speed: 0.5-70 m/min; preferably 5-45 m/min.

The surface embossing of the base film (in particular in the case of PVC) is performed at a film temperature of 70-160° C., preferably 100-150° C. whereby the temperature of the embossing roller is between −15° C. and 70° C., preferably between 10° C. and 60° C.

Then the layers are joined in a nonpositive manner by applying pressure and temperature. The temperature is applied only from the side of the cover layer, so that the side of the base layer is not heated and in fact may even be cooled.

When using an AUMA for nonpositive joining of the individual films, the rollers that come in contact with the clear layer will be at a temperature of 160-230° C., preferably 170-195° C. and the speed at which the laminate is conveyed through the AUMA is in the range of 0.1 to 10 m/min, preferably in the range of 1-5 m/min.

Another preferred method of producing the inventive plastic webs or sheets is by nonpositive lamination of the individual films and/or prelaminated films using an apparatus having two rollers between which the films are passed under pressure. This has the advantage that the roller which is in contact with the transparent cover layer can be heated while on the other hand the roller in contact with the base layer can be cooled if necessary.

The laminate is advantageously then heated at temperatures of approximately 30 to approximately 180° C., preferably approximately 70 to approximately 120° C. This heating treatment is usually associated by shrinkage of the material. In the case of PVC, for example, heated for 6 hours at 80° C., the shrinkage will amount to approximately 0.05% to 0.3%.

After nonpositive joining of the layers, the inventive multilayer plastic web or sheet is obtained with a pronounced three-dimensional optical appearance having sharp contours. When used as a floor covering, the plastic web or sheet may be used as is, but it may also be cut or punched into smaller pieces, in particular tiles.

As mentioned above, the surface of the transparent cover layer facing the base layer may be printed already at the time of its production or shortly before being fed to the lamination machine. Additionally or alternatively, the surface of the intermediate layer (white film) facing the cover layer or the embossed surface of the base layer may already be printed or it may be printed just before being joined to the transparent cover layer.

In this way it is possible to produce a multilayer plastic web or sheet having a three-dimensional optical appearance, whereby the surface embossing of the base layer is surprisingly transferred without any loss of contour to the transparent cover layer with an extremely simple process management.

With the method according to this invention, advantageous patterning effects can also be achieved.

According to one embodiment, a multilayer plastic web or sheet is produced from a transparent cover layer, a printed white film and a surface-embossed base layer by lamination, with the tips of the profiles of the embossing of the base layer being wetted with a solvent before lamination using a foam rubber roller, for example. This results in the printed white film being dissolved on coming in contact with the tips of the profiles wetted with the solvent, so that the base layer beneath it, which usually has a dark color (e.g., brown, gray or black) becomes visible. Thus dot patterns, star patterns and the like can be produced. With an appropriate embossing of the base layer with linear elevations, however, tile joints can also be simulated in a sheeting product.

The same effect can be produced in the following way in another embodiment. A plastic web or sheet is produced from a transparent cover layer and a base layer that is embossed and printed in color on the surface, whereby the tips of the profiles of the elevations of the printed base layer are ground off with a suitable aid, e.g., abrasive paper before being joined to the transparent cover layer, so that here again, the dark base layer becomes visible through the transparent cover layer of the finished plastic web or sheet at the locations where the tips have been abraded.

In all embodiments of this invention, the surface of the finished plastic web or sheet may be provided with an additional embossing pattern to strengthen the optical appearance or to modify it and to deluster the surface, for example.

Multilayer plastic webs or sheets having a marked three-dimensional optical appearance with sharp contours, if desired, can be provided easily and inexpensively with the present invention and can be used as wall coverings, ceilings, decorative films, synthetic veneer and in particular as a floor covering.

This invention will now be explained in greater detail on the basis of the following example.

### EXAMPLE

Production of a Base Film

The substances listed in the following table are plastified in a mixing apparatus and mixed together homogeneously.

| Starting Material | Amount (wt %) |
|---|---|
| PVC scrap | 50.0 |
| S-PVC (K value: 65) | 12.0 |
| DINP (plasticizer, diisononyl | 4.0 |
| phthalate) | |
| DOP (plasticizer, dioctyl phthalate) | 4.0 |
| Epoxidized soy bean oil (stabilizer) | 2.0 |
| Antistatic | 0.2 |
| Barium zinc stabilizer | 0.2 |
| Zinc stearate (lubricant, stabilizer) | 0.4 |
| Chalk (filler) | 26.6 |
| Carbon black pigment | 0.6 |

The homogeneous mixture is shaped to form a film 2 mm thick with the help of a calender, adjusting the bulk temperature of the mixture to 178° C. and the calender temperature to 190° C. The forward speed in the calender is 28 m/min.

Then the resulting PVC film is cooled to 132° C. and provided with an embossed pattern with the help of an embossing roller at a temperature of 48.5° C. The pattern has the appearance of four-sided pyramids with a base edge length of 3 mm and an embossed depth of 1.1 mm (height difference between the base area of the pyramid and the tip of the pyramid). The embossed pattern has sharp edges and lines.

The base layer has an indentation index of 34%, measured as described above.

Producing a Print Film

The substances listed in the following table are plastified in a mixing apparatus and then are mixed together homogeneously.

| Starting Material | Amount (wt %) |
|---|---|
| S-PVC (K value: 65) | 67.4 |
| E-PVC (K value: 65) | 2.0 |
| DINP | 4.2 |
| DOP | 15.0 |
| Epoxidized soybean oil | 2.4 |
| BBP (plasticizer; benzylbutyl phthalate) | 1.2 |
| Antistatic | 0.3 |
| Titanium dioxide (white pigment) | 7.5 |

The homogeneous mixture is shaped with the help of a calender to form a film 0.11 mm thick, adjusting the bulk temperature of the mixture to 185° C. and the calender temperature to 192° C. The rate of advance in the calender is 29 m/min.

Then the resulting film is printed with a four-color pattern on one side.

PRODUCTION of a Clear Film

The substances listed in the following table are plastified in a mixing apparatus and blended together homogeneously.

| Starting Material | Amount (wt %) |
|---|---|
| S-PVC (K value: 65) | 72.9 |
| E-PVC (K value: 65) | 2.0 |
| DINP | 4.2 |
| DOP | 17.0 |
| Epoxidized soybean oil | 2.4 |
| BBP (benzylbutyl phthalate) | 1.2 |
| Antistatic | 0.3 |

The homogeneous mixture is shaped with the help of a calender to yield a film 0.6 mm thick, with the melt temperature of the mixture being set at 185° C. and the calender temperature set at 192° C. The rate of advance in the calender is 29.5 m/min.

Producing a Plastic Sheet with a Three-Dimensional Optical Appearance

To produce a plastic web, the embossed base film, the printed print film and the two clear films are arranged one above the other in such way that the embossed surface of the base layer comes in contact with the unprinted surface of the print film and the printed surface of the print film comes in contact with the first clear film. The second clear film is applied above the first clear film.

The stacked films are sent to an AUMA, the drum of which is at a temperature of 192° C. The films are sent to the AUMA in such a manner that the heated drum comes in contact with the second clear film, i.e., the outer clear film. The films are passed through the AUMA at a rate of 4.2 m/min, with the individual films being joined together in a nonpositive manner. The thickness of the resulting laminate is reduced due to distortion in the longitudinal direction during the AUMA process from the original 3.31 mm (sum of the layer thicknesses of the individual films) to 3.0 mm.

After lamination, the resulting plastic web is subjected to heating at 110° C.

The finished plastic web has a three-dimensional optical appearance whereby the lines and edges of the pyramid-shaped embossing pattern of the base film remain with sharp contours and are clearly and distinctly discernible through the clear layer.

1. Floor covering of a multilayer plastic web or sheet having a three-dimensional optical appearance, comprising a base layer that is surface embossed on one side and a transparent cover layer arranged on the embossed surface of the base layer and joined to it in a nonpositive manner, having the embossed structure transferred from the base layer in the underside of the cover layer.

2. Floor covering of a multilayer plastic web or sheet as claimed in claim 1, wherein the transparent cover layer is printed on the surface facing the base layer.

3. Floor covering of a multilayer plastic web or sheet as claimed in claim 1 or 2, wherein the embossed surface of the base layer is printed.

4. Floor covering of a multilayer plastic web or sheet as claimed in claim 1 or 2, wherein another layer is provided between the transparent cover layer and the embossed base layer.

5. Floor covering of a multilayer plastic web or sheet as claimed in claim 4, whereby the additional layer is printed on its surface which faces the cover layer.

6. Floor covering of a multilayer plastic web or sheet as claimed in claim 1, wherein the base layer is a film.

7. Floor covering of a multilayer plastic web or sheet as claimed in claim 5, wherein the base layer is a laminate of at least two films.

8. Floor covering of a multilayer plastic web or sheet as claimed in claim 1, wherein the transparent cover layer is a film.

9. Floor covering of a multilayer plastic web or sheet as claimed in claim 8, wherein the transparent cover layer is a laminate of at least two films.

10. Floor covering of a multilayer plastic web or sheet as claimed in claim 1, wherein the transparent cover layer has embossing on its surface facing away from the embossed base layer.

11. Floor covering of a multilayer plastic web or sheet as claimed in claim 10, wherein the embossing has a predetermined structure.

12. Floor covering of a multilayer plastic web or sheet as claimed in claim 10 or 11, wherein the predetermined structure is a profile with elevations and recesses, the average distance between the profile tips in the midline (Sm) being more than 200 μm and less than 1000 μm.

13. Floor covering of a multilayer plastic web or sheet as claimed in claim 10, wherein the height of the elevations (peak-to-valley roughness) is in the range of 20 μm to 200 μm.

14. Floor covering of a multilayer plastic web or sheet as claimed in claim 1, wherein the transparent cover layer and the additional layer optionally provided between the cover layer and the base layer have a lower softening point than does the base layer.

15. Floor covering of a multilayer plastic web or sheet as claimed in claim 1, wherein a finish or a lacquer is applied to the surface of the transparent cover layer.

16. Floor covering of a multilayer plastic web or sheet as claimed in claim 1, wherein an adhesive layer is provided on the surface of the base layer facing away from the clear layer.

17. Method for producing a floor covering of a multilayer plastic web or sheeting having a three-dimensional optical appearance, comprising the following steps:
providing a layer of a thermoplastic material and embossing a surface of the layer to obtain a base layer with surface embossing on one side,
providing a transparent cover layer of a thermoplastic material,
arranging the transparent cover layer on the embossed surface of the base layer, and
nonpositive joining of the layers such that the embossing of the base layer is transferred to the surface of the transparent cover layer which is in contact with the base layer, so that the multilayer floor covering of a multilayer plastic web or sheet with a three-dimensional optical appearance is obtained.

18. Method as claimed in claim 17, wherein the transparent cover layer is printed on the surface facing the base layer before being joined to the base layer.

19. Method as claimed in claim 17 or 18, wherein the embossed surface of the base layer is printed before being joined to the transparent cover layer.

20. Method as claimed in claim 17, wherein before joining the layers, another layer is introduced between the transparent cover layer and the embossed base layer.

21. Method as claimed in claim 20, wherein the additional layer is printed on its surface which faces the transparent cover layer before being introduced between the transparent cover layer and the embossed base layer.

22. Method as claimed in claim 17, wherein the base layer is a film.

23. Method as claimed in claim 22, wherein the base layer is a laminate of at least two films.

24. Method as claimed in claim 17, wherein the transparent cover layer is a film.

25. Method as claimed in claim 24, wherein the transparent cover layer is a laminate of at least two films.

26. Method as claimed in claim 17, wherein the transparent cover layer is embossed on its surface which faces away from the base layer either before or after being joined to the embossed base layer and optionally the additional layer.

27. Method as claimed in claim 17, wherein the nonpositive joining of the layers is accomplished using temperature and pressure.

28. Method as claimed in claim 17, wherein the transparent cover layer and optionally the additional layer each have a lower softening point than the embossed base layer.

29. Method as claimed in claim 17, wherein the nonpositive joining of the layers is accomplished by passing the layers between rollers.

30. Method as claimed in claim 29, wherein the roller in contact with the cover layer is heated and/or the roller in contact with the base layer is not heated or is cooled.

31. Method as claimed in claim 17, wherein the transparent cover layer and optionally the additional layer are preheated before the nonpositive joining to the embossed base layer.

32. Method as claimed in claim 17, wherein the profile tips of the embossed base layer are wetted with a solvent before being joined to the printed additional layer and the transparent cover layer.

33. Method as claimed in claim 17, wherein the printing of the profile tips of the embossed and printed base layer is removed before joining it to the transparent cover layer.
